(19) United States
(12) Patent Application Publication
(10) Pub. No.: US 2026/0159061 A1
(43) Pub. Date: Jun. 11, 2026

(54) ELECTROMECHANICAL BRAKE AND CONTROL METHOD THEREOF, AND COMPUTER-READABLE STORAGE MEDIUM

(71) Applicant: HL MANDO CORPORATION, Gyeonggi-do (KR)

(72) Inventor: Jinseok KIM, Gyeonggi-do (KR)

(21) Appl. No.: 19/260,504

(22) Filed: Jul. 6, 2025

(30) Foreign Application Priority Data
Aug. 19, 2024 (KR) 10-2024-0110410

(51) Int. Cl. B60T 17/22; B60T 13/74; F16D 55/226; F16D 65/18; F16D 121/24; F16D 127/06

(52) U.S. Cl. CPC B60T 17/22; B60T 13/746; F16D 65/18; F16D 55/226; F16D 2121/24; F16D 2127/06

(57) ABSTRACT

An electromechanical brake may include a first actuator configured to generate a driving force for braking or releasing braking; a gear configured to receive the driving force from the first actuator, rotate for braking or releasing braking, and have one or more grooves; a detent housing; a detent coupled to the detent housing to pivot between an insertion position where inserted into any one of the one or more grooves and a non-insertion position where not inserted into any one of the one or more grooves, and engaged with the groove at the insertion position to restrict the rotation of the gear; a second actuator configured to pivot the detent from the non-insertion position to the insertion position; and a controller configured to control the first actuator and the second actuator, wherein the controller is configured to displace the first actuator in one direction during parking braking to generate a parking braking force, actuate the second actuator so that the detent pivots from the non-insertion position to the insertion position, and attempt to displace the first actuator in the other direction.

### CROSS-REFERENCE TO RELATED APPLICATION

This application claims priority to and benefit from Korean Patent Application No. 10-2024-0110410, filed on Aug. 19, 2024, the disclosure of which is incorporated herein by reference in its entirety.

### TECHNICAL FIELD

The present disclosure relates to an electromechanical brake, a control method thereof, and a computer-readable storage medium in which a program for performing the above method is stored, and more particularly, to an electromechanical brake using an electric actuator and a mechanical operation method, a control method thereof, and a computer-readable storage medium in which a program for performing the method is stored.

### RELATED ART

In recent years, electromechanical brakes (EMB) using electric actuators and mechanical operation methods have been introduced. Electromechanical brakes have a faster response speed than conventional hydraulic methods, and allow precise and independent control of each wheel of the vehicle. In addition, autonomous driving of the vehicle may be easily implemented through an electromechanical brake.

The electromechanical brake is configured to convert the torque of the actuator into parking braking force through a gear during parking braking. In addition, the electromechanical brake has a locking structure that prevents reverse rotation of the gear to maintain a stable parking braking state.

If the locking structure is incompletely formed after parking braking, there is a risk that the parking braking state will be released even by a small impact. Therefore, in order to increase the safety of parking braking, it is necessary to prevent incomplete formation of the locking structure.

### SUMMARY

The present disclosure is to solve the problems of the related art described above, and the present disclosure is directed to providing an electromechanical brake, a control method thereof, and a non-transitory computer-readable storage medium in which a program for performing the above method is stored that prevents incomplete fastening of a locking structure for maintaining a parking braking force while a vehicle is parked.

In addition, the present disclosure is also directed to providing an electromechanical brake, a control method thereof, and a non-transitory computer-readable storage medium in which a program for performing the above method is stored that prevents incomplete fastening of a locking structure to maintain parking braking force while a vehicle is parked through a control algorithm without additional devices.

The objects of the present disclosure are not limited to the above-described objects, and other objects that are not mentioned will be able to be clearly understood by those skilled in the art to which the present disclosure pertains from the following description.

According to an aspect of the present disclosure, provided is an electromechanical brake, including a first actuator configured to generate a driving force for braking or releasing braking; a gear configured to receive the driving force from the first actuator, rotate for braking or releasing braking, and have one or more grooves; a detent housing; a detent coupled to the detent housing to pivot between an insertion position where inserted into any one of the one or more grooves and a non-insertion position where not inserted into any one of the one or more grooves, and engaged with the groove at the insertion position to restrict the rotation of the gear; a second actuator configured to pivot the detent from the non-insertion position to the insertion position; and a controller configured to control the first actuator and the second actuator, wherein the controller is configured to displace the first actuator in one direction during parking braking to generate a parking braking force, actuate the second actuator so that the detent pivots from the non-insertion position to the insertion position, and attempt to displace the first actuator in the other direction.

In the electromechanical brake according to an aspect of the present disclosure, the controller may control the first actuator and the second actuator to release the parking braking force when the displacement of the first actuator in the other direction is not achieved as a result of the attempt to displace the first actuator.

In the electromechanical brake according to an aspect of the present disclosure, after controlling the first actuator and the second actuator to release the parking braking force, the controller may displace the first actuator in one direction during parking braking to generate a parking braking force, actuate the second actuator so that the detent pivots from the non-insertion position to the insertion position, and attempt to displace the first actuator in the other direction.

In the electromechanical brake according to an aspect of the present disclosure, the controller may stop the displacement of the first actuator in the other direction when the displacement of the first actuator in the other direction proceeds beyond a predetermined range as a result of the attempt to displace the first actuator in the other direction.

In the electromechanical brake according to an aspect of the present disclosure, after stopping the displacement of the first actuator in the other direction, the controller may displace the first actuator in one direction during parking braking to generate a parking braking force, actuate the second actuator so that the detent pivots from the non-insertion position to the insertion position, and attempt to displace the first actuator in the other direction.

In the electromechanical brake according to an aspect of the present disclosure, the controller may determine that the parking braking is completed when the displacement of the first actuator in the other direction is stopped after proceeding within a predetermined range as a result of the attempt to displace the first actuator in the other direction.

In the electromechanical brake according to an aspect of the present disclosure, the first actuator may be configured as a motor, and the controller may rotate the first actuator in one direction or the other direction.

In the electromechanical brake according to an aspect of the present disclosure, the second actuator may include a solenoid and a pin arranged to be displaceable with respect to the solenoid.

The electromechanical brake according to an aspect of the present disclosure may further include an elastic member arranged to press the detent in a direction from the non-insertion position toward the insertion position.

In the electromechanical brake according to an aspect of the present disclosure, the detent may pivot to the non-insertion position by the elastic member when the engagement with the groove is released in a non-operation state of the second actuator.

In the electromechanical brake according to an aspect of the present disclosure, the elastic member may include a first fixing portion coupled to a pivot shaft of the detent on one side of the detent; a second fixing portion coupled to the pivot shaft on the other side of the detent; and a connection portion configured to connect the first fixing portion and the second fixing portion and press one surface of the detent facing the gear in a direction from the insertion position toward the non-insertion position.

According to another aspect of the present invention, provided is an electromechanical brake control method, including displacing a first actuator in one direction that transfers driving force to a gear having one or more grooves so that the gear is rotated to apply a parking braking force; operating a second actuator to pivot a detent so that the detent is from a non-insertion position where not inserted into any one of the one or more grooves to an insertion position where inserted into any one of the one or more grooves; and transmitting a control signal for displacement in the other direction to the first actuator.

The electromechanical brake control method according to another aspect of the present disclosure may further include releasing the parking braking force if the first actuator is not displaced in the other direction despite the control signal.

In the electromechanical brake control method according to another aspect of the present disclosure, the releasing the parking braking force may include stopping the operation of the second actuator so that the pivot of the detent to the insertion position is not forced; and displacing the first actuator by a predetermined range in one direction so that the engagement between the detent and the groove is released and the detent pivots to the non-insertion position.

In the electromechanical brake control method according to another aspect of the present disclosure, after the releasing the parking braking force, it may be performed again from the displacing the first actuator in one direction.

The electromechanical brake control method according to another aspect of the present disclosure may further include stopping the displacement of the first actuator in the other direction if the first actuator is displaced in the other direction according to the control signal, but the displacement of the first actuator proceeds beyond a predetermined range.

In the electromechanical brake control method according to another aspect of the present disclosure, in the stopping the displacement of the first actuator in the other direction, the operation of the second actuator may be also stopped together with the stop of the displacement of the first actuator in the other direction.

In the electromechanical brake control method according to another aspect of the present disclosure, after stopping the displacement of the first actuator in the other direction, it may be performed again from the displacing the first actuator in one direction.

The electromechanical brake control method according to another aspect of the present disclosure may further include maintaining the parking braking force if the first actuator is displaced in the other direction according to the control signal, but the displacement of the first actuator proceeds within a predetermined range.

According to yet another aspect of the present invention, provided is a non-transitory computer-readable storage medium having stored thereon a program including at least one instruction for performing an electromechanical brake control method, the method including displacing a first actuator in one direction that transfers driving force to a gear having one or more grooves so that the gear is rotated to apply a parking braking force; operating a second actuator to pivot a detent so that the detent is from a non-insertion position where not inserted into any one of the one or more grooves to an insertion position where inserted into any one of the one or more grooves; and transmitting a control signal for displacement in the other direction to the first actuator.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of an electromechanical brake according to an exemplary embodiment of the present disclosure;

FIG. 2 is a view illustrating an electromechanical brake according to an exemplary embodiment of the present disclosure with a portion of a second housing removed;

FIG. 3 is a view illustrating an electromechanical brake according to an exemplary embodiment of the present disclosure with a second housing and controller removed;

FIG. 4 is a view illustrating in detail a gear, detent housing, detent, second actuator, and elastic member of an electromechanical brake according to an exemplary embodiment of the present disclosure;

FIG. 5 is an exploded perspective view of a gear of an electromechanical brake according to an exemplary embodiment of the present disclosure;

FIG. 6 is a view illustrating a disassembled state of a detent housing, detent, second actuator, and elastic member of an electromechanical brake according to an exemplary embodiment of the present disclosure;

FIG. 7 is a view illustrating a portion of the detent housing cut away in a state in which a detent housing, detent, second actuator, and elastic member of an electromechanical brake according to an exemplary embodiment of the present disclosure are combined;

FIG. 8 is a view illustrating the arrangement of a detent and gear of an electromechanical brake according to an exemplary embodiment of the present disclosure when the detent is at a non-insertion position;

FIG. 9 is a view illustrating the arrangement of a detent and gear of an electromechanical brake according to an exemplary embodiment of the present disclosure when the detent is engaged with a groove at an insertion position;

FIGS. 10 to 13 are views illustrating an operation process during parking braking of an electromechanical brake according to an exemplary embodiment of the present disclosure;

FIG. 14 is a graph illustrating operations of a first actuator and a second actuator when parking braking of an electromechanical brake according to an exemplary embodiment of the present disclosure is normally performed;

FIG. 15 is a view illustrating a state in which the engagement between a detent and a groove of a gear is incomplete during the parking braking of an electromechanical brake according to an exemplary embodiment of the present disclosure.

FIG. 16 is a graph illustrating operations of a first actuator and a second actuator when the engagement between a detent and a groove of a gear is incomplete during the parking braking of an electromechanical brake according to an exemplary embodiment of the present disclosure;

FIG. 17 is a view illustrating a state in which the engagement between a detent and a groove of a gear fails during the parking braking of an electromechanical brake according to an exemplary embodiment of the present disclosure;

FIG. 18 is a graph illustrating operations of a first actuator and a second actuator when the engagement between a detent and a groove of a gear fails during the parking braking of an electromechanical brake according to an exemplary embodiment of the present disclosure;

FIG. 19 is a flowchart of an electromechanical brake control method according to an exemplary embodiment of the present disclosure; and

FIG. 20 is a detailed flowchart of releasing a parking braking force in an electromechanical brake control method according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

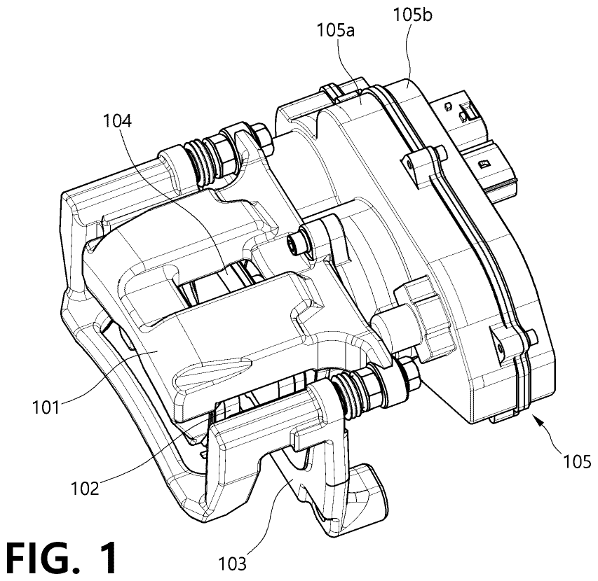

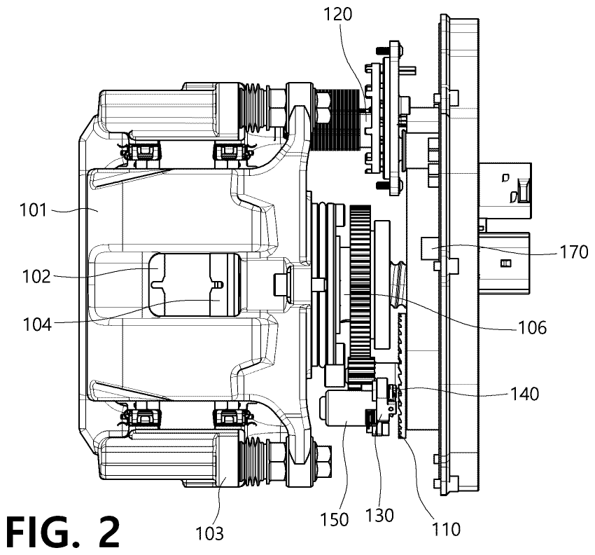

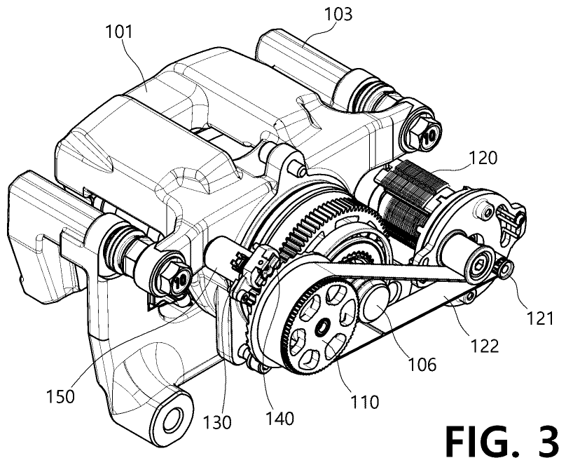

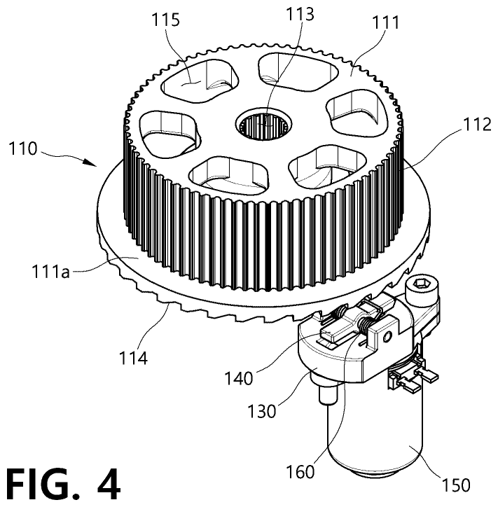

FIG. 1 is a perspective view of an electromechanical brake according to an exemplary embodiment of the present disclosure. FIG. 2 is a view illustrating an electromechanical brake according to an exemplary embodiment of the present disclosure with a portion of a second housing removed. In addition, FIG. 3 is a view illustrating an electromechanical brake according to an exemplary embodiment of the present disclosure with a second housing and controller removed. FIG. 4 is a view illustrating in detail a gear, detent housing, detent, second actuator, and elastic member of an electromechanical brake according to an exemplary embodiment of the present disclosure.

The electromechanical brake 100 according to an exemplary embodiment of the present disclosure generates a braking force in an electromechanical manner. More specifically, the electromechanical brake 100 according to an exemplary embodiment of the present disclosure may include a first actuator 120 for generating a braking force during driving or parking of a vehicle. For example, the first actuator 120 may be a motor.

The electromechanical brake 100 according to an exemplary embodiment of the present disclosure may include a first housing 101, a carrier 103, a first brake pad 102, and a second brake pad 104. The carrier 103 is coupled to the first housing 101 to be relatively displaceable with respect to the first housing 101. In this case, the first brake pad 102 and the second brake pad 104 may be disposed on the carrier 103 to face each other. In this case, a disk (not shown) coupled to a wheel of a vehicle and rotating together with the wheel may be disposed between the first brake pad 102 and the second brake pad 104.

When the second brake pad 104 is displaced toward the first brake pad 102 and comes into contact with the inner surface of the disk by a driving mechanism 106, relative displacement occurs between the first housing 101 and the carrier 103, and the first brake pad 102 also comes into contact with the outer surface of the disk. Accordingly, braking of the vehicle is performed.

The driving mechanism 106 may include a ball screw, a nut, and the like. In an embodiment of the present disclosure, the rotational force of the first actuator 120 may be transmitted to the driving mechanism 106 through a gear 110.

The second housing 105 may be coupled to the first housing 101. The second housing 105 may include a second housing main body 105a on which the driving mechanism 106 for displacing the carrier 103 is disposed and a second housing cover 105b that covers the open portion of the second housing main body 105a and is coupled to the second housing main body 105a.

Referring to FIGS. 1 to 4, the electromechanical brake 100 according to an exemplary embodiment of the present disclosure may include a gear 110, a first actuator 120, a detent housing 130, a detent 140, a second actuator 150, an elastic member 160, and a controller 170.

The gear 110 rotates for braking or releasing the braking. The gear 110 is arranged to provide power for braking when rotating in one direction and to provide power for releasing the braking state when rotating in the other direction. The gear 110 receives a rotational force of the first actuator 120 and transmits the rotational force to the driving mechanism 106. When the gear 110 rotates in one direction, the driving mechanism 106 may operate in a direction of generating a braking force, and when the gear 110 rotates in the other direction, the driving mechanism 106 may operate in a direction of releasing the braking force.

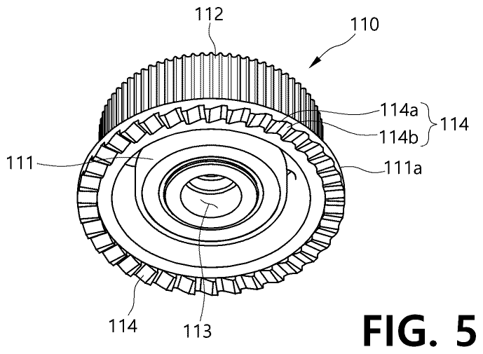

FIG. 5 is an exploded perspective view of a gear of an electromechanical brake according to an exemplary embodiment of the present disclosure.

Referring to FIG. 5, the gear 110 may include a gear body 111, a gear tooth 112, a shaft coupling portion 113, and a groove 114.

The gear body 111 may have a cylindrical shape. The gear body 111 may have a flange 111a extending outward in the radial direction on one end surface in the longitudinal direction.

The gear tooth 112 may be disposed on the outer circumferential surface of the gear body 111. The gear tooth 112 may be coupled to the output shaft of the first actuator 120 and disposed to be engaged with a belt 122 that transmits the rotational force of a rotating driving gear 121. In other words, the driving force of the first actuator 120 may be transmitted to the driving gear 121 coupled to the output shaft of the first actuator 120, and may be transmitted from the driving gear 121 to the gear 110 by the belt 122 connecting the driving gear 121 and the gear 110.

The shaft coupling portion 113 is disposed on the gear body 111 so that the rotation shaft of the gear 110 is coupled. In an embodiment of the present disclosure, the shaft coupling portion 113 may be formed as a coupling hole penetrating the center of the gear body 111 in the longitudinal direction. A rotation shaft of the gear 110 may be coupled to the shaft coupling portion 113, and a transmission gear that transmits a rotational force of the gear 110 to the driving mechanism 106 may be coupled onto the rotation shaft.

The groove 114 is disposed on the gear body 111. In an embodiment of the present disclosure, the groove 114 may be disposed on an end surface facing the detent 140 among both ends of the gear body 111 in the longitudinal direction. A plurality of grooves 114 may be arranged at regular intervals along the circumferential direction.

In an embodiment of the present disclosure, the groove 114 may be disposed on the flange 111a extending outward in the radial direction from one end surface in the longitudinal direction of the gear body 111. The flange 111a increases the diameter of the gear 110. Therefore, when the groove 114 is disposed in the flange 111a of the gear body 111, the torque may be increased when the groove 114 and the detent 140 are engaged.

In an embodiment of the present disclosure, the groove 114 may include an inclined recessed portion 114a recessed obliquely at a first angle from one end surface of the gear body 111 in the longitudinal direction, and a fastening wall 114b formed at a second angle from one end of the inclined recessed portion 114a in the recessed direction. Here, the first angle may be defined as an angle formed by the longitudinal one end surface of the gear body 111 and the inclined recessed portion 114a, and the second angle may be defined as an angle formed by the longitudinal one end surface of the gear body 111 and the fastening wall 114b.

The inclined recessed portion 114a and the fastening wall 114b form a ratchet structure. When the detent 140 is inserted into the groove 114 and engaged with the groove 114, the gear 110 may rotate only in one direction (a direction in which braking force is generated), and rotation in the other direction (a direction in which the braking force is released) is limited.

Referring to FIG. 4, the gear 110 may have one or more hollow portions 115 formed in the gear body 111. The hollow portions 115 may reduce the weight of the gear 110 to increase the driving efficiency of the gear 110. The hollow portions 115 may be symmetrically disposed with respect to the rotation shaft of the gear 110 in consideration of balance when the gear 110 rotates.

The first actuator 120 supplies rotational force to the gear 110. The first actuator 120 may operate under the control of the controller 170. As described above, the first actuator 120 may be a motor. The gear 110 may rotate in one direction according to the displacement in one direction of the first actuator 120, and the gear 110 may rotate in the other direction according to the displacement in the other direction of the first actuator 120.

The detent housing 130 is arranged so that the detent 140 is movably coupled. The detent housing 130 may be disposed adjacent to the gear 110. More specifically, the detent housing 130 may be disposed to face one end surface of the gear 110 in the longitudinal direction in which the groove 114 is formed.

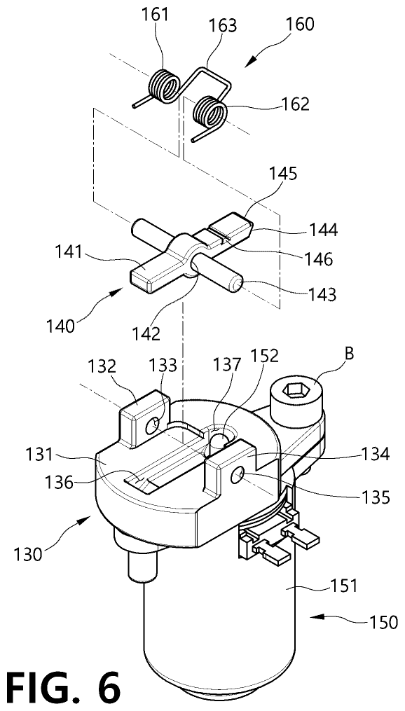

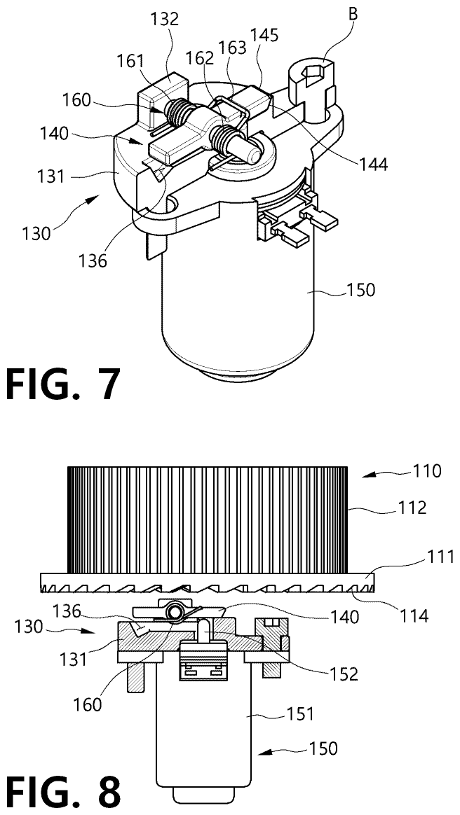

FIG. 6 is a view illustrating a disassembled state of a detent housing, detent, second actuator, and elastic member of an electromechanical brake according to an exemplary embodiment of the present disclosure. FIG. 7 is a view illustrating a portion of the detent housing cut away in a state in which a detent housing, detent, second actuator, and elastic member of an electromechanical brake according to an exemplary embodiment of the present disclosure are combined.

Referring to FIGS. 6 and 7, the detent housing 130 may include a housing main body 131, a first sidewall 132, a second sidewall 134, a pivot guide 136, and a pin guide 137.

The housing main body 131 is disposed to face one surface of the gear 110. More specifically, the housing main body 131 may be disposed to face one end surface of the gear 110 in the longitudinal direction in which the groove 114 is disposed. The housing main body 131 may have a plate shape. In this case, one surface of the housing main body 131 facing one surface of the gear 110 may be formed to be flat.

In an embodiment of the present disclosure, the housing main body 131 may be coupled to the second actuator 150. For example, the housing main body 131 may be fastened to the second actuator 150 through a bolt B.

The first sidewall 132 is connected to the housing main body 131 such that one end of the pivot shaft of the detent 140 is coupled thereto. The first sidewall 132 may extend outward from one surface of the housing main body 131. A first through hole 133 may be through-formed in the first sidewall 132 so that one end of the pivot shaft is coupled thereto.

The second sidewall 134 is connected to the housing main body 131 such that the other end of the pivot shaft of the detent 140 is coupled thereto. The second sidewall 134 may extend outward from one surface of the housing main body 131 to face the first sidewall 132. A second through hole 135 may be through-formed in the second sidewall 134 so that the other end of the pivot shaft is coupled thereto.

The pivot guide 136 is provided in the housing main body 131 to accommodate a portion of the detent 140 away from the gear 110 and guide the pivot when the detent 140 pivots to a position where it is inserted into any one of one or more grooves 114 of the gear 110 around the pivot shaft. In an embodiment of the present disclosure, the pivot guide 136 may be formed by being recessed into one surface of the housing main body 131.

The pin guide 137 may be formed to penetrate one surface and the other surface of the housing main body 131 so that a pin 152 of the second actuator 150 that pivots the detent 140 to a position where inserted into the groove 114 may contact the detent 140.

The detent 140 is coupled to the detent housing 130 to be pivotable between an insertion position where inserted into any one of the one or more grooves 114 provided in the gear 110 and a non-insertion position where not inserted into any one of the one or more grooves 114. The detent 140 may be engaged with the groove 114 at the insertion position to restrict rotation of the gear 110.

FIG. 8 is a view illustrating the arrangement of a detent and gear of an electromechanical brake according to an exemplary embodiment of the present disclosure when the detent is at a non-insertion position.

Referring to FIG. 8, the detent 140 does not limit the rotation of the gear 110 at the non-insertion position. That is, the non-insertion position may be defined as a position where the detent 140 is not engaged with the groove 114 of the gear 110.

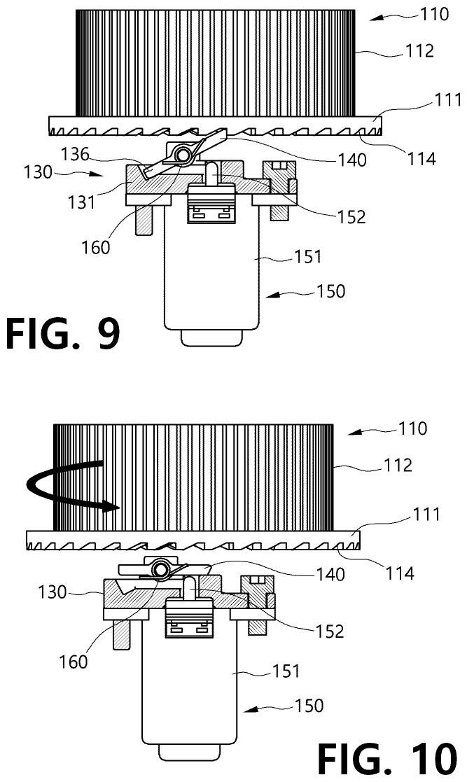

FIG. 9 is a view illustrating the arrangement of a detent and gear of an electromechanical brake according to an exemplary embodiment of the present disclosure when the detent is engaged with a groove at an insertion position.

Referring to FIG. 9, the detent 140 may restrict rotation of the gear 110 at the insertion position. The detent 140 is engaged with the groove 114 of the gear 110 at the insertion position to limit the rotation of the gear 110. An end of the detent 140 may be in contact with and engage with the fastening wall 114b at the insertion position.

More specifically, the detent 140 may restrict rotation of the gear 110 in a specific direction while being engaged with the groove 114. The detent 140 may restrict the gear 110 from rotating in a direction in which the braking force is released while being engaged with the groove 114. That is, when a braking force is generated when the gear 110 rotates in one direction and the braking force is released when the gear 110 rotates in the other direction, the detent 140 may restrict rotation of the gear 110 in the other direction while being engaged with the groove 114.

Referring to FIGS. 6 and 7, the detent 140 may have a detent body 141, a pivot shaft arrangement hole 142, a pivot shaft member 143, an inclined portion 144, a chamfering portion 145, and a detent groove 146.

The detent body 141 may have a rod shape. For example, the detent body 141 may have a quadrangular rod shape.

The pivot shaft arrangement hole 142 is formed such that the pivot shaft of the detent 140 is disposed. The pivot shaft arrangement hole 142 may be formed to pass through the detent body 141 in the transverse direction. For example, the pivot shaft arrangement hole 142 may pass through the detent body 141 in the transverse direction at the middle portion of the detent body 141.

The pivot shaft member 143 acts as a pivot shaft of the detent 140. In an embodiment of the present disclosure, the pivot shaft member 143 may be formed of a pin. In addition, the pivot shaft member 143 may be disposed to pass through the pivot shaft arrangement hole 142.

One end of the pivot shaft member 143 is disposed in a first through hole 133 of the first sidewall 132 of the detent housing 130 to be coupled to the first sidewall 132. In addition, the other end of the pivot shaft member 143 is disposed in a second through hole 135 of the second sidewall 134 of the detent housing 130 to be coupled to the second sidewall 134.

In an embodiment of the present disclosure, the detent 140 includes the pivot shaft arrangement hole 142 that penetrates the detent body 141 in the transverse direction, and has a structure in which the pivot shaft member 143 acting as a pivot shaft is disposed to pass through the pivot shaft arrangement hole 142. However, this is exemplary, and it may also be considered that the detent 140 does not have a separate pivot shaft member and the pivot shaft is integrally formed in the detent body 141.

The inclined portion 144 is disposed at one end of the detent body 141 in the longitudinal direction. More specifically, the inclined portion 144 is formed at one end of the detent body 141 in the longitudinal direction that engages with the groove 114 of the gear 110 in the insertion position.

In an embodiment of the present disclosure, the inclined portion 144 may be formed such that a distance from the pivot shaft of the detent 140 on one surface of the detent 140 facing the gear 110 is longer than a distance from the pivot shaft of the detent 140 on the other surface of the detent 140. If the inclined portion 144 is formed in such a structure, when the detent 140 is in the insertion position, one end of the detent 140 may be stably engaged with the fastening wall 114b of the groove 114 of the gear 110.

Among the detent body 141, the chamfering portion 145 is disposed at an edge between one end in the longitudinal direction that engages with the groove 114 of the gear 110 at the insertion position and one surface facing the gear 110. The chamfering portion 145 guides the detent 140 to smoothly enter the inside of the groove 114 when the detent 140 pivots to the insertion position.

The detent groove 146 is arranged so that a connection portion 163 of the elastic member 160, which will be described later, is seated. The detent groove 146 allows the connection portion 163 of the elastic member 160 to stably press the detent 140.

The detent groove 146 may be formed by being recessed into one surface of the detent body 141 that faces the gear 110. More specifically, the detent groove 146 may be disposed transversely across the detent 140.

The second actuator 150 pivots the detent 140 from the non-insertion position to the insertion position. The second actuator 150 pivots the detent 140 to the insertion position during parking braking of the vehicle so that the detent 140 engages with the gear 110. Accordingly, it is possible to prevent the parking braking state being released due to the reverse rotation of the gear 110 due to an unintended impact, etc. while the vehicle's parking brake is fastened.

In an embodiment of the present disclosure, the second actuator 150 may include a solenoid 151 and a pin 152. The pin 152 is disposed to be displaceable with respect to the solenoid 151.

When power is applied to the solenoid 151, the pin 152 may protrude outside the solenoid 151 along the longitudinal axis of the solenoid 151, and when power is not applied to the solenoid 151, the pin 152 may be introduced into the solenoid 151 along the longitudinal axis of the solenoid 151.

When the vehicle's parking braking is performed, power is applied to the solenoid 151 so that the pin 152 protrudes and presses one end of the detent 140 so that the detent 140 may pivot from the non-insertion position to the insertion position. Meanwhile, when the application of power to the solenoid 151 is stopped, the pin 152 may be introduced into the solenoid 151.

As discussed above, the second actuator 150 may be coupled to the detent housing 130. More specifically, the end of the side where the pin 152 of the second actuator 150 protrudes may be coupled to the detent housing 130. In this case, the pin 152 of the second actuator 150 may be displaced inside the pin guide 137 of the detent housing 130.

The elastic member 160 is disposed to press the detent 140 in a direction from the insertion position toward the non-insertion position. In an embodiment of the present disclosure, the elastic member 160 may be disposed to press one surface of the detent 140 facing the gear 110.

When releasing the vehicle's parking brake, the detent 140 needs to be pivoted to escape from the engagement state with the groove 114 of the gear 110. In other words, the detent 140 must be pivoted to the non-insertion position. When releasing the parking brake, the elastic member 160 presses the detent 140 in a direction from the insertion position toward the non-insertion position, thereby helping the detent 140 to be reliably pivoted to the non-insertion position.

Referring to FIGS. 6 and 7, the elastic member 160 may include a first fixing portion 161, a second fixing portion 162, and a connection portion 163.

The first fixing portion 161 is coupled to the pivot shaft of the detent 140 on one side of the detent 140 in the transverse direction. In an embodiment of the present disclosure, the first fixing portion 161 may be coupled to the pivot shaft member 143 on one side of the detent 140 in the transverse direction. The first fixing portion 161 may be a coil spring arranged to surround the outer circumferential surface of the pivot shaft member 143.

The second fixing portion 162 is coupled to the pivot shaft of the detent 140 on the other side of the detent 140 in the transverse direction. In an embodiment of the present disclosure, the second fixing portion 162 may be coupled to the pivot shaft member 143 on the other side of the detent 140 in the transverse direction. The second fixing portion 162 may be a coil spring arranged to surround the outer circumferential surface of the pivot shaft member 143.

The connection portion 163 extends to connect the first fixing portion 161 and the second fixing portion 162 to each other. The connection portion 163 presses one surface of the detent 140 facing the gear 110. In an embodiment of the present disclosure, the connection portion 163 may be integrally formed with the first fixing portion 161 and the second fixing portion 162.

The controller 170 controls the first actuator 120 and the second actuator 150. For example, the controller 170 may be implemented on a PCB. The controller 170 may receive signals for controlling the first actuator 120 and the second actuator 150 from the upper ECU of the vehicle.

In addition, the controller 170 may be configured to be a micro controller unit (MCU) or an electronic control unit (ECU). The controller 170 may include at least one arithmetic logic unit (ALU) and a processing register. In addition, the controller 170 may include a memory for storing data.

When the first actuator 120 is configured as a motor, the controller 170 may rotate the first actuator 120 in one direction or the other direction. In addition, when the second actuator 150 includes a solenoid 151, the controller 170 may apply or release the power to the solenoid 151.

In an embodiment of the present disclosure, the controller 170 generates a parking braking force by displacing the first actuator 120 in one direction during parking braking, actuates the second actuator 150 so that the detent 140 pivots from the non-insertion position to the insertion position, and attempts to displace the first actuator 120 in the other direction.

FIGS. 10 to 13 are views illustrating an operation process during parking braking of an electromechanical brake according to an exemplary embodiment of the present disclosure.

A parking braking process by the controller 170 will be described with reference to FIGS. 10 to 13.

First, as shown in FIG. 10, the gear 110 is rotated to displace the first actuator 120 in one direction so that a parking braking force is applied. The controller 170 may control the first actuator 120 such that the gear 110 rotates in one direction until an appropriate parking braking force is secured.

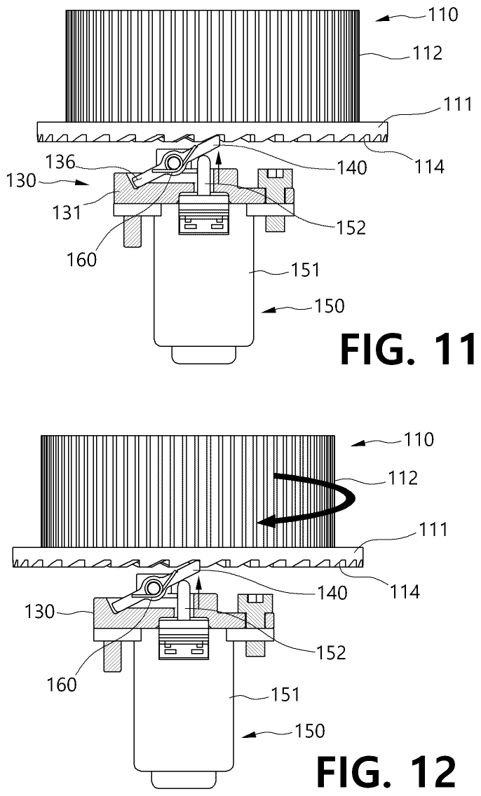

Next, as shown in FIG. 11, it operates the second actuator 150 to pivot the detent 140 so that the detent 140 is from the non-insertion position to the insertion position. For example, the controller 170 may apply power to the solenoid 151 and accordingly cause the pin 152 to protrude to press the detent 140 to pivot the detent 140.

When the second actuator 150 is operated, the pressing force of the pin 152 is greater than the pressing force of the elastic member 160. Accordingly, the detent 140 may be pivoted from the non-insertion position to the insertion position by overcoming the pressing force of the elastic member 160.

Referring to FIG. 11, the detent 140 enters any one of the one or more grooves 114 in a state in which the detent 140 is pivoted to the insertion position. However, the detent 140 is not in a state in which it is in contact with the fastening wall 114b and engaged with the groove 114.

Next, as shown in FIG. 12, the gear 110 is rotated to displace the first actuator 120 in the other direction so that the detent 140 and the groove 114 is engaged. The controller 170 may displace the first actuator 120 in the other direction until the detent 140 is still in contact with the fastening wall 114b and is engaged with the groove 114, so that the rotation of the gear 110 is restricted.

Referring to FIG. 12, the detent 140 is still in contact with the fastening wall 114b and is engaged with the groove 114. Accordingly, rotation of the gear 110 in the other direction, that is, in a direction in which the parking braking force is released, is restricted, and the parking braking state may be stably maintained.

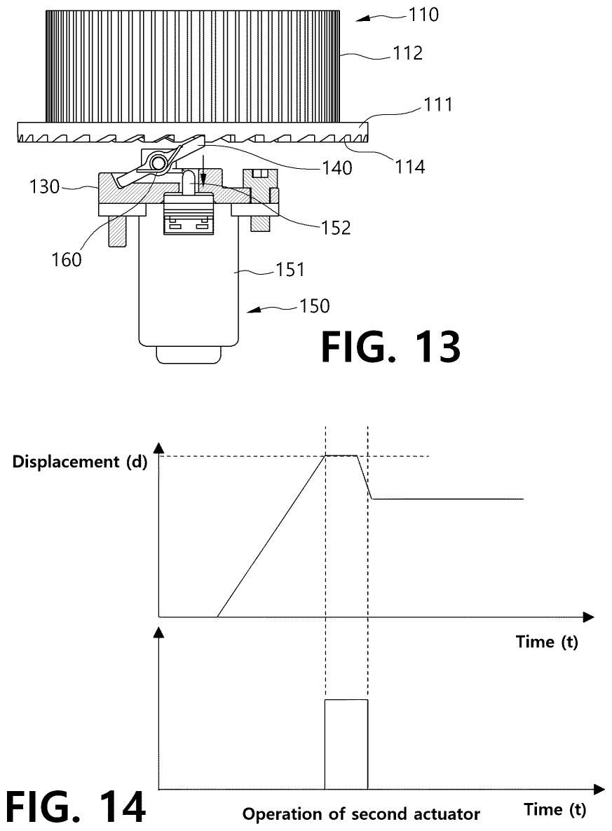

Finally, as shown in FIG. 13, the operation of the second actuator 150 is stopped so that the pivot of the detent 140 to the insertion position is not forced. For example, the controller 170 stops power being applied to the solenoid 151 to displace the pin 152 toward the solenoid 151.

Support by the second actuator 150 is not required in a state in which the detent 140 is once engaged with the groove 114. In addition, if the second actuator 150 continuously forces the pivot of the detent 140 to the insertion position, the detent 140 cannot pivot to the non-insertion position when the parking braking is to be released, and thus the parking braking cannot be released. Therefore, the operation of the second actuator 150 is stopped so that the pivot of the detent 140 to the insertion position is not forced.

FIG. 14 is a graph illustrating operations of a first actuator and a second actuator when parking braking of an electromechanical brake according to an exemplary embodiment of the present disclosure is normally performed.

In FIG. 14, the upper graph shows a displacement (d) of the first actuator 120 over time (t). Here, a direction in which the displacement (d) increases is a direction in which the braking force is formed, and a direction in which the displacement (d) decreases is a direction in which the braking force is released. Meanwhile, the lower graph shows whether the second actuator 150 is operated over time (t).

Referring to FIG. 14, when the first actuator 120 is displaced in one direction to secure a parking braking force, the second actuator 150 is operated so that the detent 140 pivots to the insertion position. In addition, when the first actuator 120 is displaced in the other direction and engaged between the detent 140 and the groove 114, the displacement of the first actuator 120 is restricted in the other direction, and the parking braking state is locked. When the parking braking state is locked, the operation of the second actuator 150 is stopped.

In this way, the controller 170 may determine that parking braking is completed when the displacement of the first actuator 120 in the other direction is stopped after progressing within a predetermined range as a result of the attempt of the other directional displacement of the first actuator 120. Here, the predetermined range may be set in advance and stored in the controller 170.

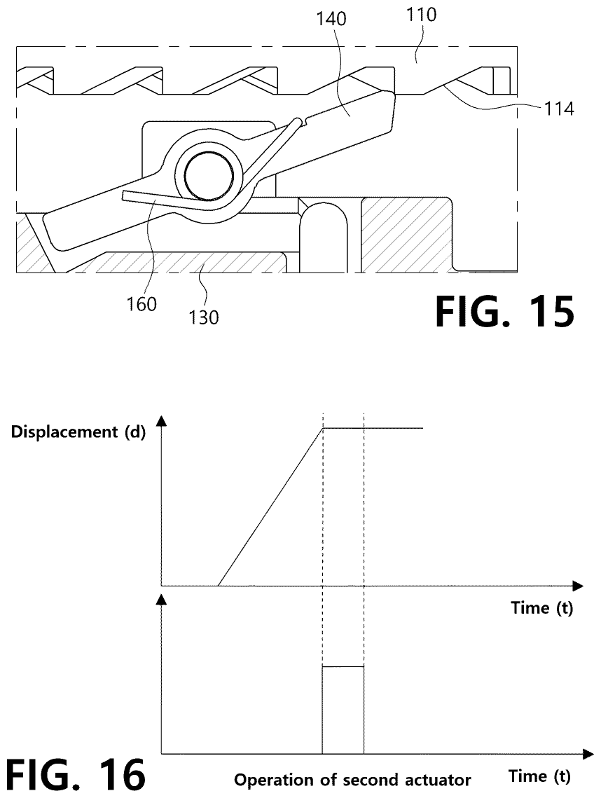

FIG. 15 is a view illustrating a state in which the engagement between a detent and a groove of a gear is incomplete during the parking braking of an electromechanical brake according to an exemplary embodiment of the present disclosure.

Referring to FIG. 15, when the second actuator 150 is operated to pivot the detent 140 to the insertion position after the first actuator 120 is displaced in one direction to secure a parking braking force, the detent 140 is not completely inserted into any one of the one or more grooves 114 and the edges of the detent 140 and the groove 114 are in contact with each other.

In this case, the locking state of the parking braking force may be secured for the moment, but the locking state of the parking braking force may be easily released as the detent 140 deviates from the groove 114 even with a small impact applied to the vehicle.

As such, in order to detect the state in which the engagement between the detent 140 and the groove 114 is incomplete, the controller 170 displaces the first actuator 120 in one direction to generate a parking braking force during parking braking, and operates the second actuator 150 so that the detent 140 pivots from the non-insertion position to the insertion position, and then attempts to displace the first actuator 120 in the other direction.

FIG. 16 is a graph illustrating operations of a first actuator and a second actuator when the engagement between a detent and a groove of a gear is incomplete during the parking braking of an electromechanical brake according to an exemplary embodiment of the present disclosure.

In FIG. 16, the upper graph shows a displacement (d) of the first actuator 120 over time (t). Here, a direction in which the displacement (d) increases is a direction in which the braking force is formed, and a direction in which the displacement (d) decreases is a direction in which the braking force is released. Meanwhile, the lower graph shows whether the second actuator 150 is operated over time (t).

Referring to FIG. 16, when the first actuator 120 is displaced in one direction to secure a parking braking force, the second actuator 150 is operated so that the detent 140 pivots to the insertion position. If the engagement between the detent 140 and the groove 114 is incomplete, as shown in FIG. 15, the detent 140 is in contact with the fastening wall 114b of the groove 114, so the rotation of the gear 110 in the direction of releasing the parking braking force is restricted, so displacement of the first actuator 120 in the other direction is also not performed.

In consideration of this, if the first actuator 120 is not displaced in the other direction as a result of the attempt to displace the first actuator 120 in the other direction, the controller 170 may consider this as an incomplete engagement state between the detent 140 and the groove 114 and control the first actuator 120 and the second actuator 150 to release the parking braking force.

Specifically, the controller 170 stops the operation of the second actuator 150 so that the pivot of the detent 140 to the insertion position is not forced. In addition, the engagement between the detent 140 and the groove 114 is released, and the first actuator 120 is displaced by a predetermined range in one direction so that the detent 140 pivots to the non-insertion position. Accordingly, the detent 140 is pivoted to the non-insertion position when the elastic member 160 is pressed.

In addition, after controlling the first actuator 120 and the second actuator 150 to release the parking braking force, the controller 170 may displace the first actuator 120 in one direction to generate a parking braking force, operate the second actuator 150 so that the detent 140 pivots from the non-insertion position to the insertion position, and attempt to displace the first actuator 120 in the other direction. In other words, the controller 170 may re-perform the parking braking process.

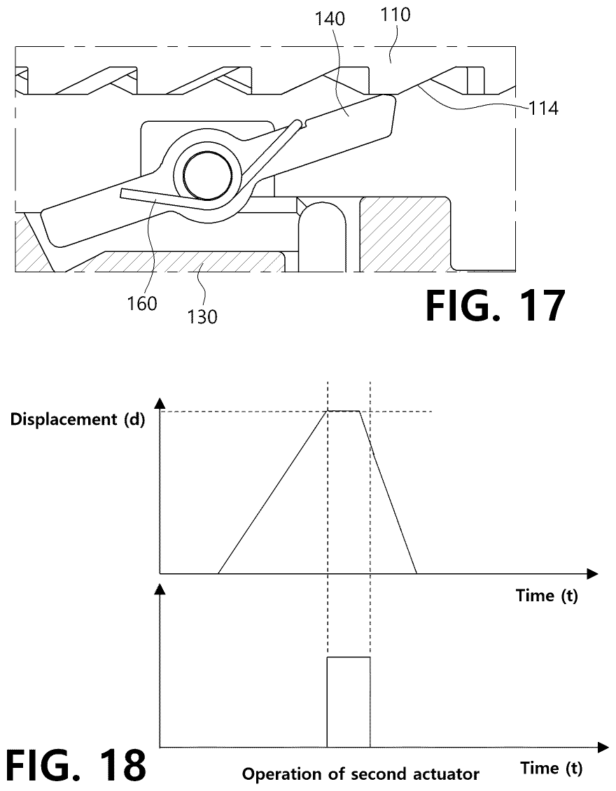

FIG. 17 is a view illustrating a state in which the engagement between a detent and a groove of a gear fails during the parking braking of an electromechanical brake according to an exemplary embodiment of the present disclosure.

Referring to FIG. 17, when the second actuator 150 is operated to pivot the detent 140 to the insertion position after the first actuator 120 is displaced in one direction to secure a parking braking force, the detent 140 is not inserted into any one of the one or more grooves 114 and the detent 140 is in contact with the body of the gear 110 between the grooves 114. In this case, the locking state of the parking braking force cannot be secured.

As such, in order to detect the pivot of the detent 140 to the insertion position or the failure of the engagement between the detent 140 and the groove 114, the controller 170 displaces the first actuator 120 in one direction to generate a parking braking force during parking braking, and operates the second actuator 150 so that the detent 140 pivots from the non-insertion position to the insertion position, and then attempts to displace the first actuator 120 in the other direction.

FIG. 18 is a graph illustrating operations of a first actuator and a second actuator when the engagement between a detent and a groove of a gear fails during the parking braking of an electromechanical brake according to an exemplary embodiment of the present disclosure.

In FIG. 18, the upper graph shows a displacement (d) of the first actuator 120 over time (t). Here, a direction in which the displacement (d) increases is a direction in which the braking force is formed, and a direction in which the displacement (d) decreases is a direction in which the braking force is released. Meanwhile, the lower graph shows whether the second actuator 150 is operated over time (t).

Referring to FIG. 18, when the first actuator 120 is displaced in one direction to secure a parking braking force, the second actuator 150 is operated so that the detent 140 pivots to the insertion position. If the engagement between the stopper 140 and the groove 114 fails, as shown in FIG. 17, the detent 140 cannot restrict the rotation of the gear 110 in the direction of releasing the parking braking force, so the displacement of the first actuator 120 in the other direction proceeds beyond a predetermined range.

In consideration of this point, the controller 170 may stop the displacement of the first actuator 120 in the other direction when the displacement of the first actuator 120 in the other direction proceeds beyond a predetermined range as a result of the attempt to displace the first actuator 120 in the other direction. In this case, the predetermined range may be determined in advance and stored in the controller 170.

In addition, after stopping the displacement of the first actuator 120 in the other direction, the controller 170 may displace the first actuator 120 in one direction to generate a parking braking force, operate the second actuator 150 so that the detent 140 pivots from the non-insertion position to the insertion position, and attempt to displace the first actuator 120 in the other direction. In other words, the controller 170 may re-perform the parking braking process.

The electromechanical brake 100 according to an exemplary embodiment of the present disclosure has been described above in detail. Hereinafter, an electromechanical brake control method according to an exemplary embodiment of the present disclosure will be described.

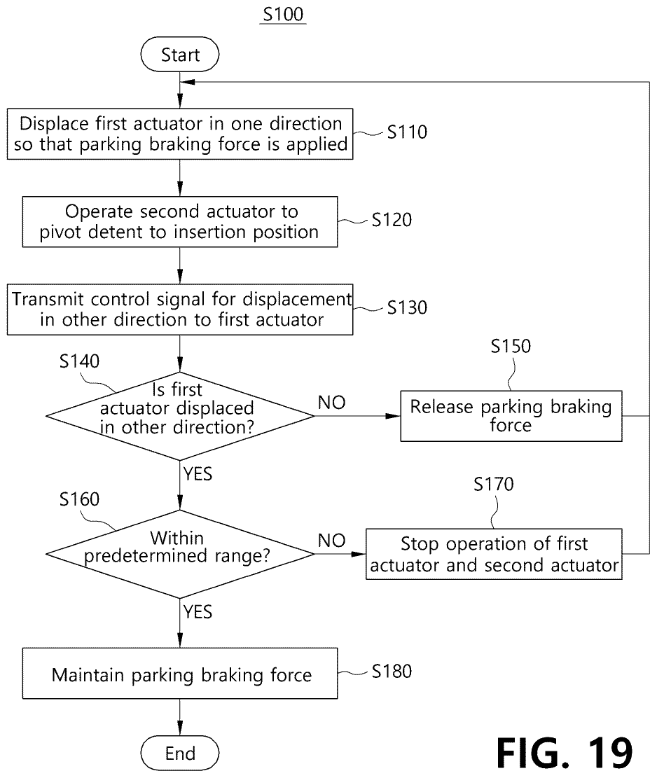

FIG. 19 is a flowchart of an electromechanical brake control method according to an exemplary embodiment of the present disclosure.

Referring to FIG. 19, an electromechanical brake control method S100 according to an exemplary embodiment of the present disclosure may be performed as follows. The electromechanical brake control method S100 may be performed by the controller 170.

First, the first actuator 120 is displaced in one direction so that a parking braking force is applied (S110). In more detail, the gear 110 having one or more grooves 114 is rotated to displace the first actuator 120 that transmits a driving force to the gear 110 in one direction so that a parking braking force is applied.

Next, the second actuator 150 is operated to pivot the detent 140 to the insertion position (S120). The second actuator 150 is operated to pivot the detent 140 so that the detent 140 is from the non-insertion position to the insertion position.

When the second actuator 150 includes a solenoid 151 and a pin 152, the controller 170 may apply power to the solenoid 151 so that the pin 152 protrudes.

Next, a control signal for displacement in the other direction is transmitted to the first actuator 120 (S130). When the first actuator 120 is configured as a motor, the controller 170 may transmit a control signal for rotation in the other direction to the first actuator 120.

Next, it is determined whether the first actuator 120 is displaced in the other direction (S140). For example, if the first actuator 120 is configured as a motor, the controller 170 may determine whether it is displaced in the other direction based on sensing information about the position of the motor.

Next, if the first actuator 120 is not displaced in the other direction despite the control signal, the parking braking force is released (S150). If the first actuator 120 is not displaced in the other direction despite the control signal, it may be regarded as a case in which the engagement between the detent 140 and the groove 114 is incomplete as discussed in connection with FIGS. 15 and 16. Therefore, after the parking braking is released, the parking braking procedure proceeds again.

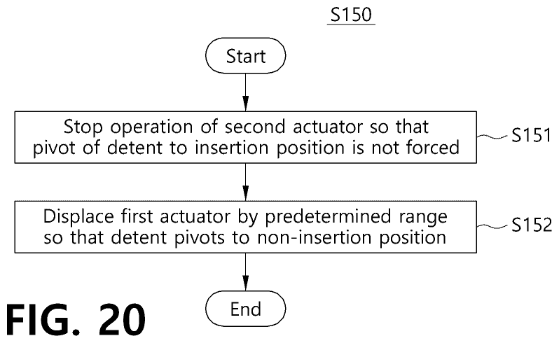

FIG. 20 is a detailed flowchart of releasing a parking braking force in an electromechanical brake control method according to an exemplary embodiment of the present disclosure.

Referring to FIG. 15, the step S150 of releasing the parking braking force may be performed as follows.

First, the operation of the second actuator 150 is stopped so that the pivot of the detent 140 to the insertion position is not forced (S151).

Next, the engagement between the detent 140 and the groove 114 is released, and the first actuator 120 is displaced by a predetermined range in one direction so that the detent 140 pivots to the non-insertion position (S152).

After the step S150 of releasing the parking braking force, the step S110 of displacing the first actuator 120 in one direction may be performed again.

Meanwhile, when the first actuator 120 is displaced in the other direction according to the control signal, it is determined whether the displacement of the first actuator 120 in the other direction is within a predetermined range (S160). In this case, the predetermined range may be determined in advance and stored in the controller 170.

Next, if the first actuator 120 is displaced in the other direction according to the control signal, but the displacement of the first actuator 120 in the other direction proceeds beyond a predetermined range, the displacement of the first actuator 120 in the other direction is stopped (S170). If the first actuator 120 is displaced in the other direction according to the control signal, but the displacement of the first actuator 120 in the other direction proceeds beyond a predetermined range, it may be considered that the engagement between the detent 140 and the groove 114 failed as discussed in connection with FIGS. 17 and 18.

In this case, the controller 170 may also stop the operation of the second actuator 150 while stopping the displacement of the first actuator 120 in the other direction. When the second actuator 150 includes a solenoid 151 and a pin 152, the controller 170 may release the power applied to the solenoid 151 so that the pin 152 is introduced.

After the step S170 of stopping the displacement of the first actuator 120 in the other direction, it may be performed again from the step S110 of displacing the first actuator 120 in one direction.

Finally, when the first actuator 120 is displaced in the other direction according to the control signal, but the displacement of the first actuator 120 in the other direction is within a predetermined range, the parking braking force is maintained (S180).

In addition, the present disclosure provides a non-transitory computer-readable storage medium having stored thereon a program for performing the electromechanical brake control method S100. Specifically, the present disclosure may provide a non-transitory computer-readable storage medium having stored thereon a program including at least one instruction for performing the electromechanical brake control method S100.

In this case, the instruction may include not only machine code generated by a compiler but also higher level language code executable by a computer. In addition, the storage medium may include a hardware device such as a magnetic medium such as a hard disk, a floppy disk and a magnetic tape; an optical medium such as a compact disk read only memory (CD-ROM) and a digital video disk (DVD); a magneto-optical medium such as a floptical disk; a read-only memory (ROM); a random access memory (RAM); a flash memory; and the like.

As the program is executed by the controller 170, a step of displacing the first actuator 120 that transmits a driving force to the gear 110 in one direction so that the gear 110 having one or more grooves 114 is rotated to apply a parking braking force (S110), a step of operating the second actuator 150 to pivot the detent 140 so that the detent 140 is from a non-insertion position where not inserted into any one of the one or more grooves 114 to an insertion position where inserted into any one of the one or more grooves 114 (S120), a step of transmitting a control signal for displacement in the other direction to the first actuator 120 (S130), and the like may be performed.

According to the above configuration, according to the present disclosure, safety is improved by ensuring the complete formation of a locking structure for maintaining a parking braking force while a vehicle equipped with an electromechanical brake is parked.

In addition, according to the present disclosure, the complete formation of a locking structure for maintaining a parking braking force of an electromechanical brake can be efficiently achieved through a control algorithm without additional devices such as sensors.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An electromechanical brake, comprising:
a first actuator configured to generate a force for braking or releasing the braking;
a gear configured to be rotatable by the force generated by the first actuator and having one or more grooves;
a detent configured to be pivotable between an insertion position where the detent is inserted into one of the one or more grooves of the gear and a non-insertion position where the detent is not inserted in any one of the one or more grooves of the gear, wherein the detent is configured to restrict rotation of the gear when the detent is engaged with one of the one or more grooves of the gear;
a second actuator configured to move the detent from the non-insertion position to the insertion position; and
a controller configured to control the first actuator and the second actuator,
wherein the controller is configured to control the first actuator to generate the force in one direction to generate a parking braking force, control the second actuator to move the detent from the non-insertion position to the insertion position, and, after the detent is moved to the insertion position, control the first actuator to attempt to generate the force in another direction.

2. The electromechanical brake of claim 1, wherein the controller is configured to control the first actuator and the second actuator to release the parking braking force when the attempting to generate the force in the another direction by the first actuator fails.

3. The electromechanical brake of claim 2, wherein the controller is configured to, after controlling the first actuator and the second actuator to release the parking braking force, control the first actuator to generate the force in the one direction to re-apply the parking braking force, control the second actuator to move the detent from the non-insertion position to the insertion position, and, after the detent is moved to the insertion position, control the first actuator to attempt to generate the force in the another direction.

4. The electromechanical brake of claim 1, wherein the controller is configured to stop the controlling of the first actuator to generate the force in the another direction when displacement of a displaceable part of the first actuator in the another direction is out of a predetermined range by attempting to generate the force in the another direction.

5. The electromechanical brake of claim 4, wherein the controller is configured to, after stopping the controlling of the first actuator to generate the force in the another direction, control the first actuator to generate the force in the one direction to generate the parking braking force, control the second actuator to move the detent from the non-insertion position to the insertion position, and control the first actuator to attempt to generate the force in the another direction.

6. The electromechanical brake of claim 1, wherein the controller is configured to determine that parking braking is completed when displacement of a displaceable part of the first actuator in the another direction is stopped after the displaceable part of the first actuator is displaced within a predetermined range by attempting to generate the force in the another direction.

7. The electromechanical brake of claim 1, wherein the first actuator comprises a motor, and the controller is configured to rotate the motor of the first actuator.

8. The electromechanical brake of claim 1, wherein the second actuator comprises a solenoid and a pin arranged to be displaceable with respect to the solenoid.

9. The electromechanical brake of claim 1, further comprising an elastic member configured to apply an elastic force to the detent in a direction from the non-insertion position toward the insertion position.

10. The electromechanical brake of claim 9, wherein the detent is configured to be movable to the non-insertion position by the elastic member when the second actuator is in a non-actuated state.

11. The electromechanical brake of claim 9, wherein the elastic member comprises a connection portion connecting one portion of the elastic member is coupled to a pivot shaft of the detent on one side of the detent and another portion of the elastic member is coupled to the pivot shaft on another side of the detent and configured to press one surface of the detent facing the gear in a direction from the insertion position toward the non-insertion position.

12. An electromechanical brake control method, comprising:
controlling a first actuator to generate a force in one direction to apply a parking braking force;
transferring the force to a gear having one or more grooves;
controlling a second actuator to move a detent from a non-insertion position where the detent is not inserted in any one of the one or more grooves of the gear to an insertion position where the detent is inserted into one of the one or more grooves of the gear; and
transmitting a control signal for generating the force in another direction to the first actuator.

13. The electromechanical brake control method of claim 12, further comprising releasing the parking braking force if a displaceable part of the first actuator is not displaced in the another direction in response to the control signal for generating the force in the another direction.

14. The electromechanical brake control method of claim 13,
wherein the releasing of the parking braking force comprises:
stopping actuation of the second actuator so that a force for moving the detent toward the insertion position is not generated; and
actuating the first actuator to displace the displaceable part of the first actuator in the one direction within a predetermined range so that engagement between the detent and the one or more grooves of the gear is released and the detent is moved to the non-insertion position.

15. The electromechanical brake control method of claim 13, further comprising, after the releasing of the parking braking force, actuating the first actuator to generate the force in the one direction.

16. The electromechanical brake control method of claim 12, further comprising stopping the actuating of the first actuator if displacement of a displaceable part of the first actuator in the another direction in response to the control signal is out of a predetermined range.

17. The electromechanical brake control method of claim 16, further comprising, when the actuating of the first actuator is stopped, stopping actuation of the second actuator.

18. The electromechanical brake control method of claim 16, further comprising, after stopping the actuating of the first actuator, re-actuating the first actuator to generate the force in the one direction.

19. The electromechanical brake control method of claim 12, further comprising maintaining the parking braking force if displacement of a displaceable part of the first actuator in the another direction in response to the control signal is within a predetermined range.

20. A non-transitory computer-readable storage medium having at least one instruction that, when executed by one or more processors, cause the one or more processors to:
control a first actuator to generate a force in one direction to apply a parking braking force, wherein the gear has one or more grooves;
control a second actuator to move a detent from a non-insertion position where the detent is not inserted in any one of the one or more grooves of the gear to an insertion position where the detent is inserted into one of the one or more grooves of the gear; and
transmit a control signal for generating the force in another direction to the first actuator.
